(19) United States
(12) Patent Application Publication
(10) Pub. No.: US 2013/0286189 A1
(43) Pub. Date: Oct. 31, 2013

(54) SOLDER CONNECTION INSPECTION APPARATUS AND METHOD

(71) Applicants: Assad Shafie, Northbrook, IL (US); David A. Froh, Northbrook, IL (US)

(72) Inventors: Assad Shafie, Northbrook, IL (US); David A. Froh, Northbrook, IL (US)

(73) Assignee: Indak Manufacturing Corp., Northbrook, IL (US)

(21) Appl. No.: 13/455,244

(22) Filed: Apr. 25, 2012

(51) Int. Cl. G01N 21/88; H04N 7/18

(52) U.S. Cl. 348/126; 356/237.1; 348/E07.085

(57) ABSTRACT

In accordance to an embodiment, there is provided an apparatus for inspecting at least one through-hole solder connection on a PCB. The device includes a light source and a light sensor on opposite sides of the PCB. If light is sensed, the solder connection is defective.

### BACKGROUND OF THE INVENTION

The present disclosure generally relates to inspection devices, and particularly to an inspection device for inspecting solder deposited in holes in printed circuit boards (PCBs) with through-hole electronic components. In the manufacture of electronic assemblies, through-hole mounting refers to the mounting scheme used for electronic components that use leads on the components. The leads are inserted through holes in printed circuit boards (PCBs) either by hand placement or by the use of automated insertion machines and then soldered to the PCBs.

Manufacturing defects are common during the soldering process. If solder does not completely fill the hole in the PCB, the electrical and/or mechanical connection will not be as strong as it could be. Therefore, it is important to inspect the solder following the soldering process to determine whether the solder has completely filled the hole.

One method of identifying defective soldering uses a technology known as automated optical inspection (AOI). AOI technology generally utilizes a light source for perpendicularly projecting light beams onto the surface of the solder, and a camera for capturing light beams reflected from the solder, thereby generating an image of the solder. However, these machines often fail to detect small unacceptable voids in the solder, or falsely indicate that a good solder is defective.

Therefore, it is desired to provide an imaging device for reliably inspecting solder.

### SUMMARY OF THE INVENTION

To overcome this problem, there is provided a method and apparatus to inspect at least one solder connection for a through-hole component mounted on a printed circuit board. The invention includes a light source and a camera or light sensor mounted in diametrical opposition to one another. The printed circuit board with the at least one solder connection corresponding to a through-hole mounting on a printed circuit board is passed between the light source and the camera or light sensor. If light is detected then the solder connection is defective.

Other aspects of the invention may include building upon this by having a diffuser screen positioned between the light source and the camera and having the PCB with the through-hole mounting pass between the camera and the diffuser screen.

In yet another aspect of the invention an apparatus may be provided to detect defective solder connections on multiple assemblies at the same time. Each assembly would include a PCB with at least one through-hole mounting with a solder connection. The apparatus may utilize a tray to hold the multiple assemblies in place and which moves the tray between the light source and camera or light sensor. The detection of light through any through-hole mountings for the multiple assemblies would indicate a defective solder connection for that particular Assembly.

In yet a further aspect a computer, software, and a display may be provided to image one or more assemblies and to image a defective or an acceptable assembly. The software on the computer would be configured to convert signals from the camera for the construction of an image of the assemblies. The software is further configured to analyze the image to identify a defective solder connection and to identify on a display the location where a defective solder connection is found.

Numerous other advantages and features of the invention will become readily apparent from the following detailed description of the invention and the embodiments thereof, from the claims, and from the accompanying drawings.

### BRIEF DESCRIPTION OF THE DRAWINGS

A fuller understanding of the foregoing may be had by reference to the accompanying drawings, wherein:

FIG. 1 is a perspective view of an embodiment of the present invention illustrating a an inspection apparatus for manually inspecting a through-hole solder connection;

FIG. 2 is a perspective view of the inspection apparatus of FIG. 1 with an assembly mounted therein;

FIG. 3 is a perspective view of FIG. 2 showing a defective solder connection;

FIG. 4 is a perspective view of a solder connection inspection apparatus in accordance with another embodiment of the present invention;

FIG. 5 is a perspective view of FIG. 4 showing an opened access panel;

FIG. 6 is a partial front view of the solder connection inspection apparatus;

FIG. 7 is a partial front view of the solder connection inspection apparatus;

FIG. 8 is a rendering of a display showing the testing results of a tray of assemblies;

FIG. 9 is a partial view of the tray of assemblies positioned over a light source;

FIGS. 10A and 10B are enlarged views of an assembly having solder connections for illustrating acceptable solder connections and a defective solder connections;

FIG. 11 is a perspective view of a tray without assemblies; and

FIG. 12 is a perspective view of the tray holding assemblies.

### DETAILED DESCRIPTION OF THE EMBODIMENTS

While the invention is susceptible to embodiments in many different forms, there are shown in the drawings and will be described herein, in detail, the preferred embodiments of the present invention. It should be understood, however, that the present disclosure is to be considered an exemplification of the principles of the invention and is not intended to limit the spirit or scope of the invention and/or claims of the embodiments illustrated.

In the following description, for simplicity, it will be assumed that there is only one solder connection. Furthermore, in the following description, a “defect” or “defects” may include at least one portion of the solder having too little solder, solder irregularly distributed, no solder, or any combination of these defects.

In a first and preferred embodiment there is provided a method in accordance with one aspect of the present invention. The method includes the steps of providing a light source and a camera or light sensor positioned such that the two are diametrically opposed. A printed circuit board (PCB) or assembly having at least one through-hole mounting component and solder connection is passed between the light source and the camera or light sensor. Inspection of the solder connection is then made and if light is detected then the solder connection is defective. The inspection can be done manually or automatically. If done automatically, a machine or apparatus would detect the light through the solder connection indicating that the connection was not correctly soldered and then providing an indication either on a display or an audible indication that the assembly or PCB has a defective solder connection.

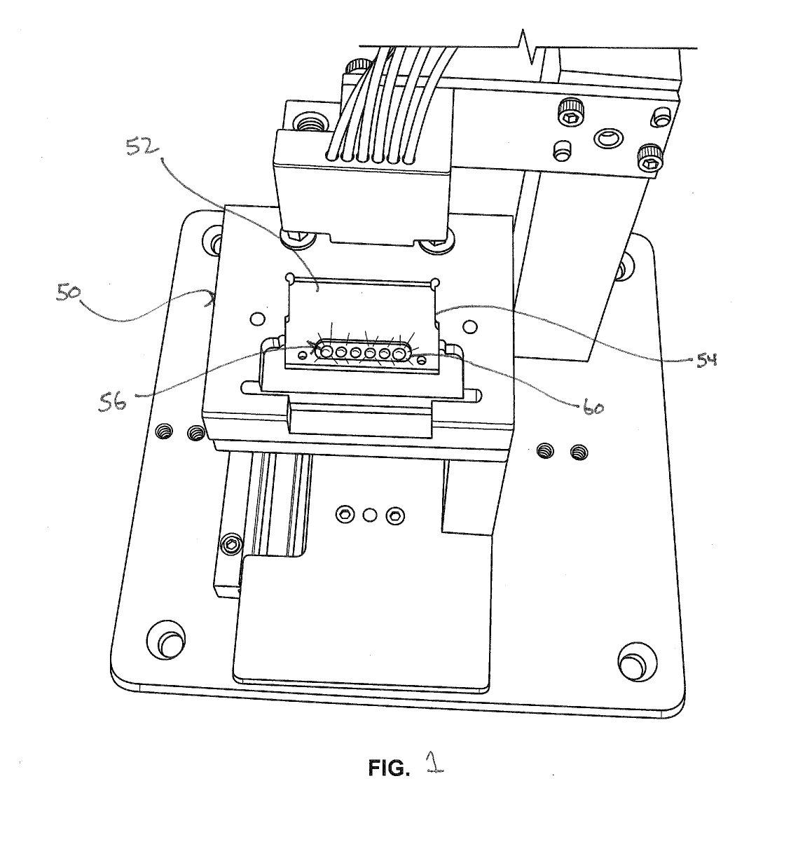

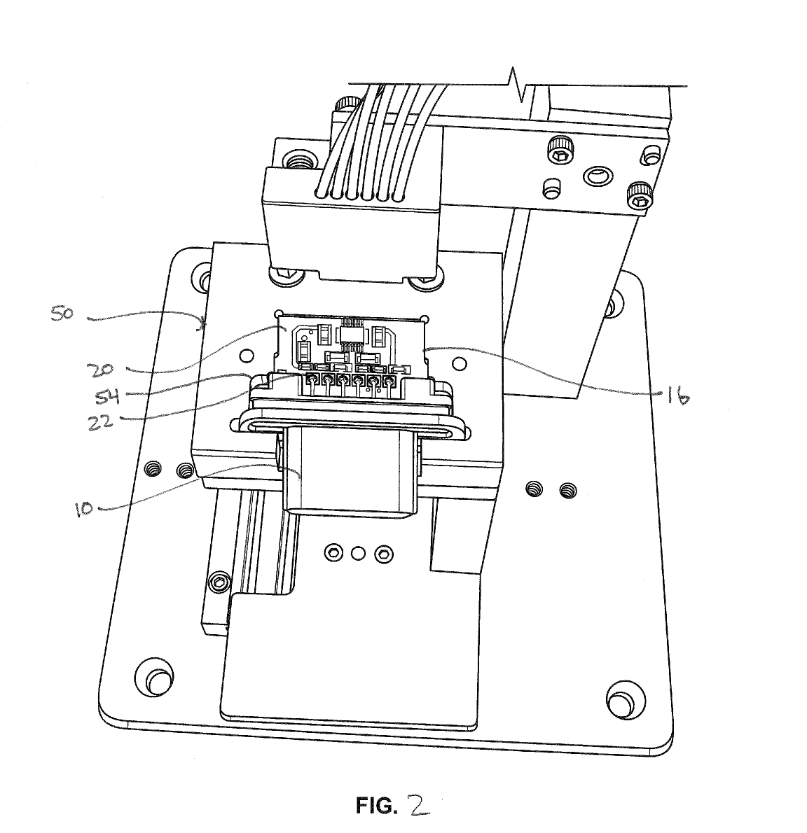

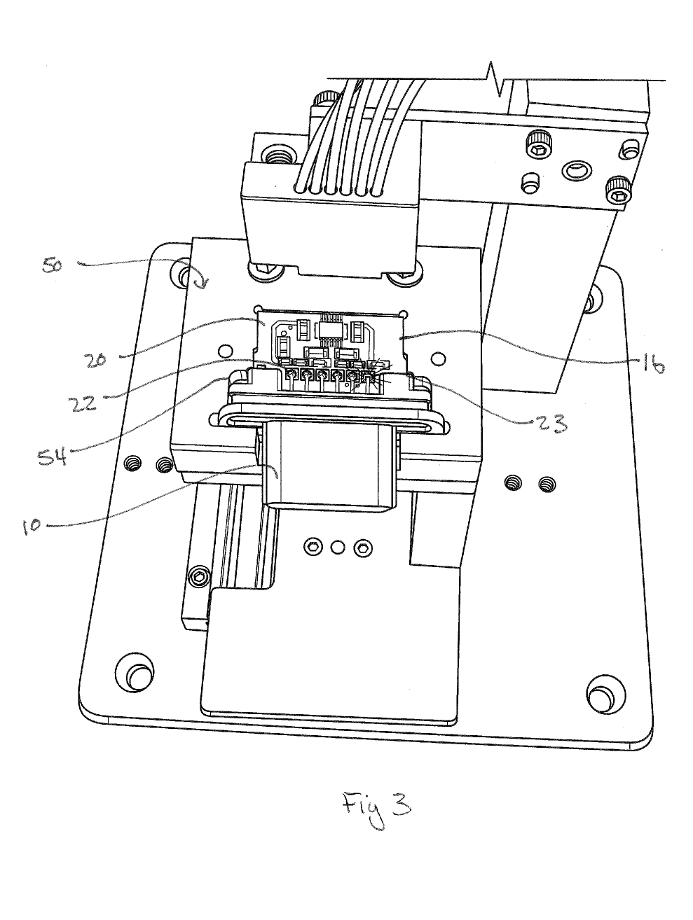

Referring now to FIG. 1-3 an apparatus 50 is provided in accordance with one embodiment of the present invention. The apparatus 50 provides for a manual placement of an assembly 10 that includes a printed circuit board (PCB) 20 with at least one through-hole component mounted thereto. The apparatus 50 further provides for the inspection of a through-hole solder connection 22. The apparatus 50 includes a notched section 52 that has a profile 54 corresponding to at least a portion of a profile 16 of the assembly 10. Positioned within the notched section is at least one light source 56 corresponding to the placement of the one or more through-holes on the PCB. Once the assembly 10 is placed in the notched section 52, and more specifically sit within the notched section 52, the at least one light source 56 can direct a light towards at least one solder connection 22. An inspection of the assembly in the notched section 52 would follow and if light is detected, it would indicate a defective solder connection 23.

In other variations, at least one light source 56 can be an array of light emitting diodes 58, one LED for each solder connection. The light source 56 can also be positioned within a channel 60 defined within the notched section 52 to help ensure the light source 56 does not interfere with the placement of the assembly 10. In addition, a camera or light sensor can be positioned opposite the light source to aid in detecting any defective solder connections.

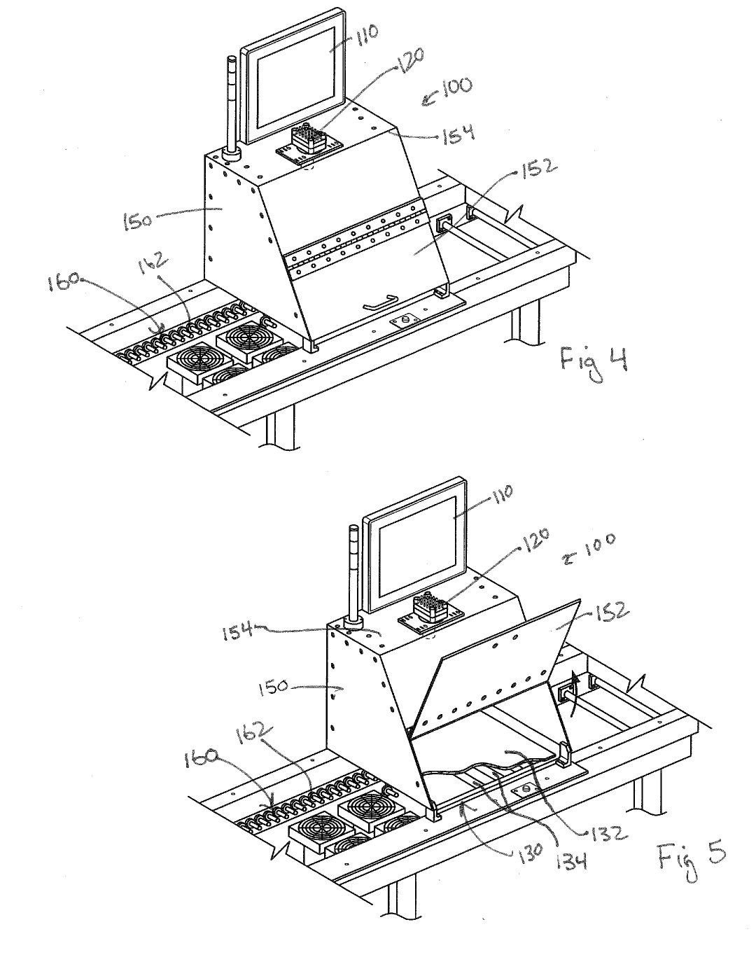

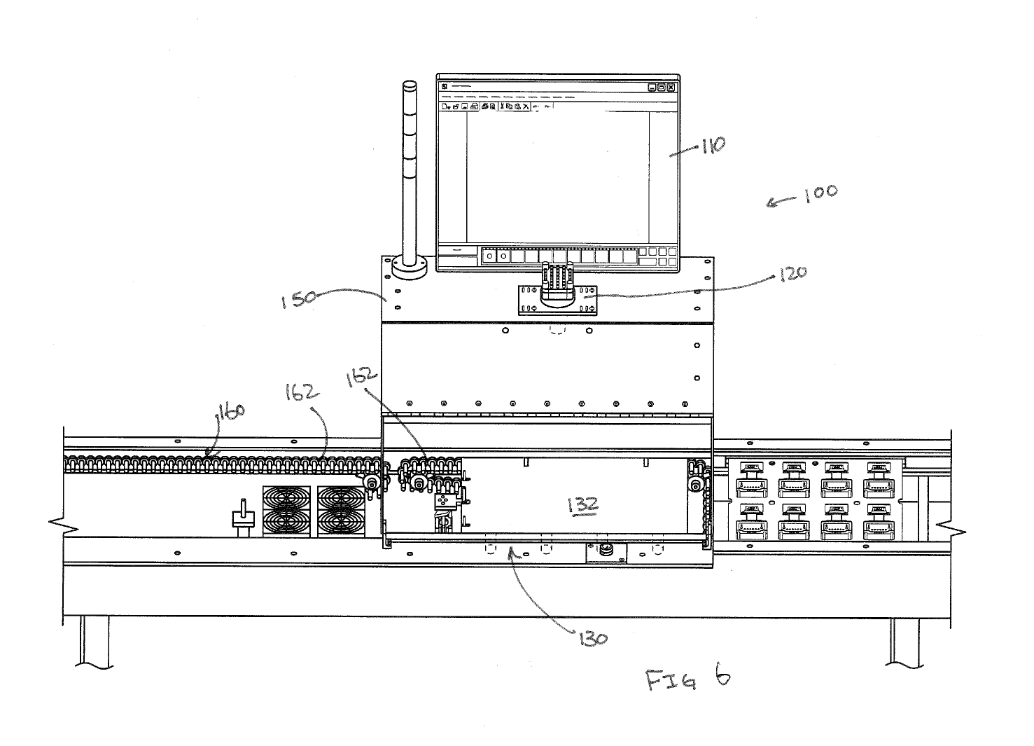

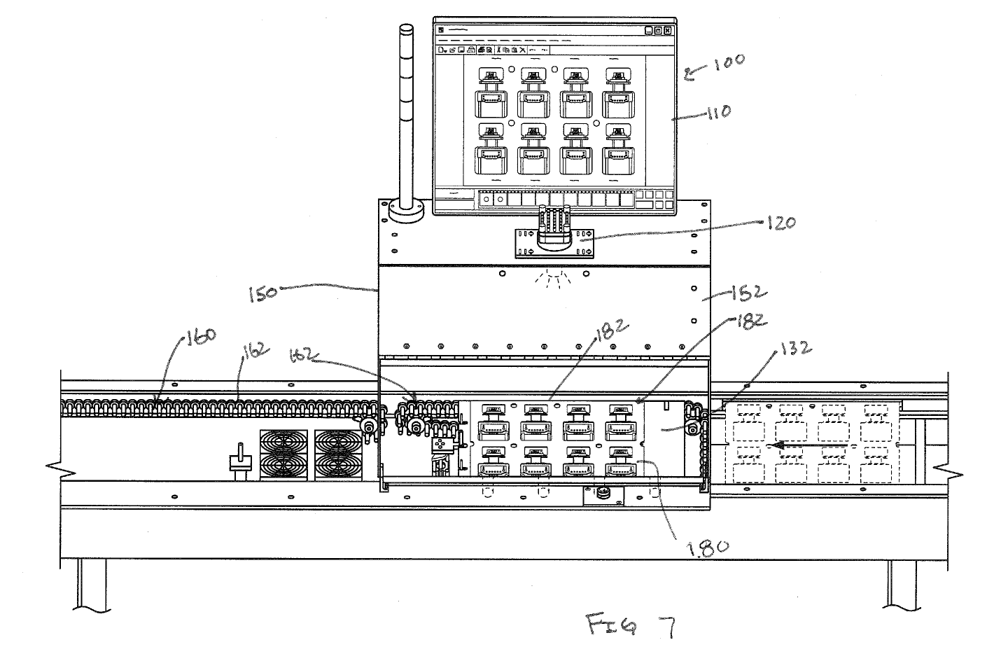

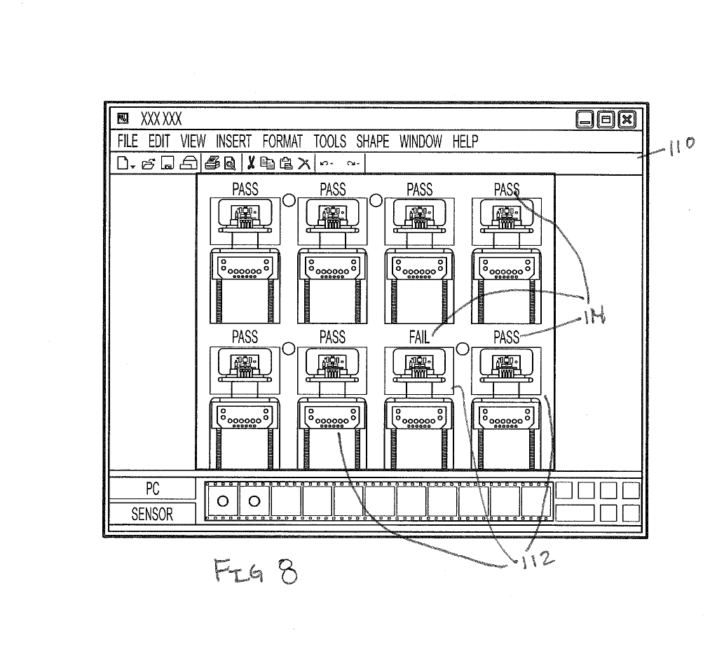

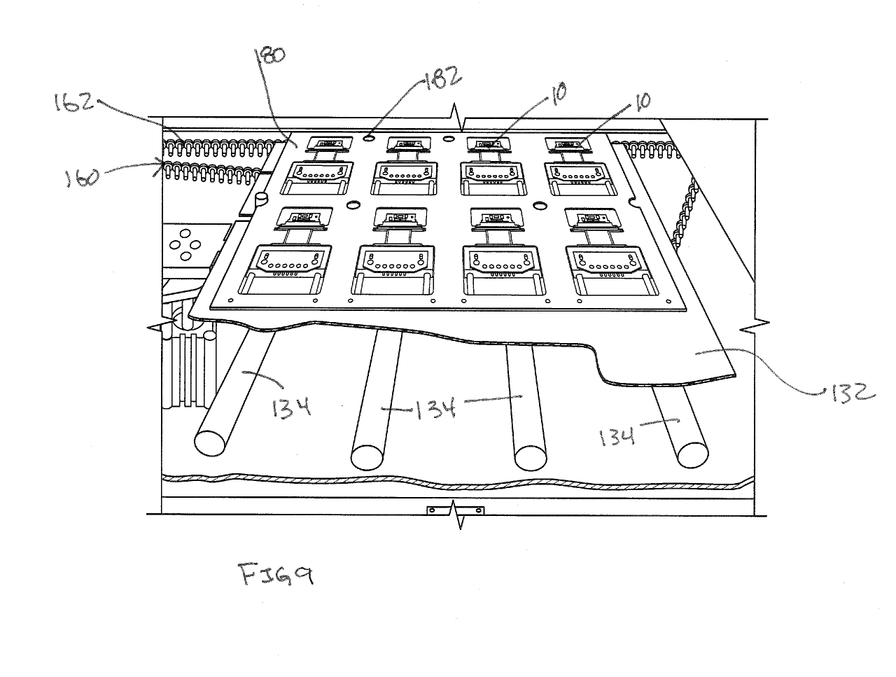

Referring to FIGS. 4-10B, an apparatus 100 is provided in accordance with another embodiment of the present invention. The apparatus 100 is configured to display images of assemblies 10 having at least one solder connection 22 for a through-hole component mounted to printed circuit board (PCB) 20. The apparatus 100 further includes a means to analyze the images to determine if the at least one solder connection 22 has a defect.

The apparatus 100 includes a camera 120 or light sensor and a light source 130. It may also include, but does not necessarily require a display 110 and a computer (not shown) having software configured to run the particular items as described herein. The computer and display may be separable components or designed together as a PDA, laptop, tablet computer, etc.

The light source 130 is capable of projecting light towards the assemblies 10 and more particularly towards the through-holes and into the solder connection 22. The camera 120 or light sensor is mounted diametrically opposed to the light source 130. As such the camera 120 and light source 130 may be mounted in any particular orientation (up/down or side/side or any angled combination thereof); as long as the two diametrically oppose each other. The assembly 10 is then moved between the light source 130 and the camera 120, such that the light projects towards the through-holes and into the solder connection 22. Once captured by the camera or detected by the light sensor, the software is configured to convert the signals, and construct an image by processing the electrical signals.

Once positioned between the camera and the light source, an image of the assembly is taken. The software is configured to detect any light filtering through the solder connection 22. A display 110 can be configured to show an image 112 of one or more of the assemblies 10 and may indicate a pass/fail notice 114 over the assembled component 10.

The light source 130 may include a diffuser panel 132 or diffuser screen and bulbs 134. It has been found that light through the diffuser panel 132 helps evenly distribute the light over all of the assemblies.

The apparatus may be designed as part of a housing construct 150 positioned to hold the camera and light source and positioned if desired over a conveyor belt system 160. The conveyor belt system 160 would be designed to move the assemblies 10 across the light source 130 and through the housing construct 150. The housing construct 150 may include a hinged front panel 152 to provide access to the camera 120 or light sensor and the lighting source 130.

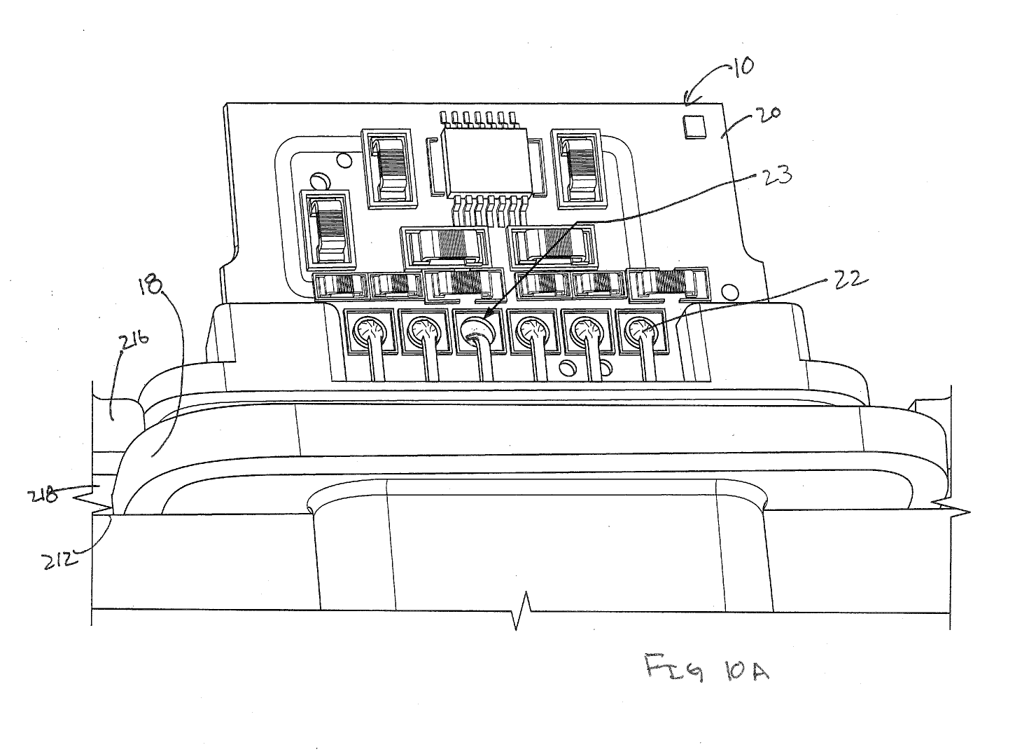

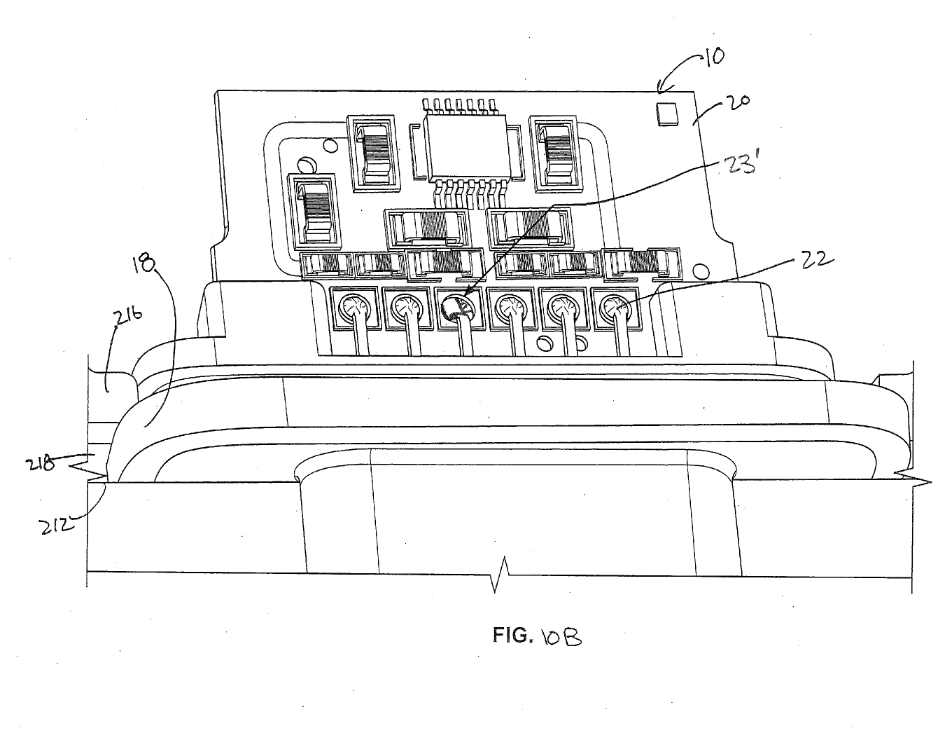

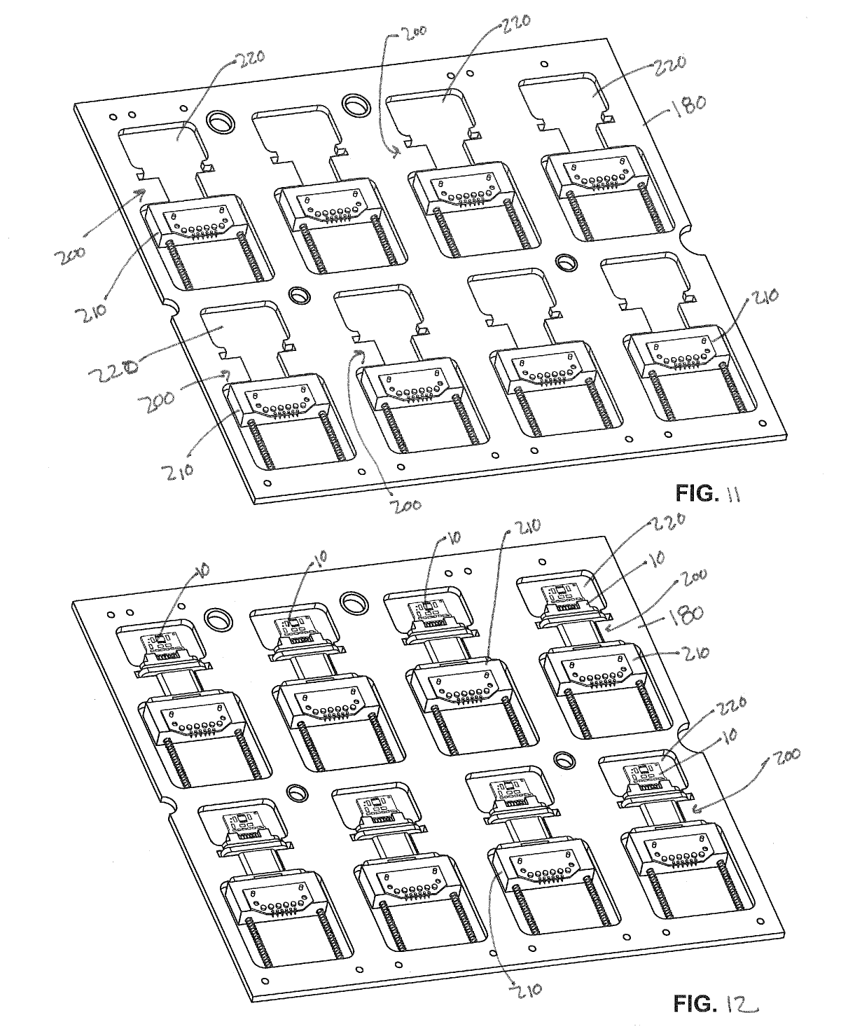

The assemblies 10 may, but do not necessarily have to be placed in a tray 180 and held in position by the tray. The tray 180 includes at least one edge 182 that meshes to an edge 162 of the conveyor belt system 160 such that when the conveyor belt system 160 moves the tray 180 moves through the housing construct 150 and between the light source 130 and the camera 120. The apparatus is configured as described above such that the camera and/or display can be used to help detect defects. As soon as the tray is moved out of the housing construct, the operator can remove the failed assembly and determine if the assembly 10 needs to be re-soldered. A visual check of the solder connection 22 may show that the assembly 10 includes a missing solder connection 23 (FIG. 10A) or a partial solder connection 23′ (FIG. 10B) either of which is recognized as a defective solder connection.

The tray 180 includes a plurality of testing stages 200, each testing stage 200 is designed to receive and hold an assembly 10 in position. Each testing stage may include a stage electrical testing component 210 to engage an assembly 10. Each stage electrical testing component would typically be configured to facilitate electrical testing of the assemblies while the assemblies are mounted in the tray. This can be done separately and apart from the inspection of the solder connections. In addition when secured to the stage electrical testing component, the assembly is positioned over an opening 220 such that when the tray 180 passes over the diffuser 132 the light source will project the light into the assembly 10 and illuminate through any defects in the solder connection 22 allowing the camera 120 or light sensor and an operator reviewing the display 110 to identify any defective solder connections 23.

From the foregoing and as mentioned above, it will be observed that numerous variations and modifications may be effected without departing from the spirit and scope of the novel concept of the invention. It is to be understood that no limitation with respect to the specific methods and apparatus illustrated herein is intended or should be inferred.

We claim:

1. A method of inspecting a through-hole solder connection comprising:
providing an assembly including of a printed circuit board having at least one through-hole and a component having at least one lead wire with a portion thereof positioned in the through-hole, and providing a solder connection in the through-hole;
providing a light source on one side of the printed circuit board to direct light towards the through-hole and the solder connection; and
inspecting the solder connection for light passing through the through-hole, wherein when light is detected through the through-hole the solder connection is defective.

2. The method of claim 1 further comprising:
providing a camera diametrically opposed to the light source; and
positioning the assembly between the camera and the light source.

3. The method of claim 2 further comprising:
diffusing the light from the light source before the light is directed towards the through-hole.

4. The method of claim 3 further comprising:
having a computer and display and providing a software component configured to image on the display an indication when the solder connection is defective.

5. The method of claim 1 further comprising:
providing a light sensor diametrically opposed to the light source; and
positioning the assembly between the camera and the light source.

6. An apparatus for inspecting an assembly, the assembly having a printed circuit board with at least one through-hole solder connection, the apparatus comprising:
a base having a notched section, the notched section defined to include a profile corresponding to at least a portion of a profile defined by the assembly; and
at least one light source positioned within the notched section and corresponding to direct a light towards the at least one through-hole solder connection when the assembly is placed within the notched section, whereupon a defective solder connection is determined when light passes through the through-hole solder connection.

7. The apparatus of claim 6, wherein the at least one light source is an array of light emitting diodes, each light emitting diode being positioned to correspond to one of the through-hole solder connections.

8. The apparatus of claim 7 further comprising a channel positioned within the notched section, the at least one light source being positioned within the channel.

9. An apparatus for inspecting at least one solder connection on a through-hole defined on a printed circuit board, the apparatus comprising:
a camera or light sensing device;
a light source diametrically opposed to the camera or light sensing device such that the printed circuit board having the at least one solder connection on the through-hole is capable of passing between the light source and the camera or light sensing device; and
a means for detecting a defective solder connection for the at least one solder connection on the through-hole.

10. The apparatus of claim 9, wherein the printed circuit board is a component of an assembly.

11. The apparatus of claim 10, wherein the means for detecting a defective solder connection includes a computer having at least a memory and a display and being in communication with at least the camera, and software defined on the computer and configured to convert signals from the camera for the construction of an image of the assembly, the software further configured to analyze the image to identify a defective solder connection and to identify on the display the assembly when a defective solder connection is present thereon.

12. The apparatus of claim 11 further comprising a conveyor belt system positioned to move the assembly between the light source and camera.

13. The apparatus of claim 10, wherein the light source includes at least one light bulb and a diffuser positioned between the at least one light bulb and the camera such that the assembly is capable of passing between the camera and diffuser.

14. The apparatus of claim 11 further comprising a tray defined to hold a plurality of assemblies, each assembly having at least one through-hole solder connection.

15. The apparatus of claim 14, wherein the tray includes a plurality of testing stages, each testing stage being defined to receive and hold an assembly.

16. The apparatus of claim 15, wherein each testing stage includes:
a stage electrical testing component having an end to engage the assembly; and
an opening positioned adjacent the stage electrical testing component such that when the assembly is engaged to the stage electrical testing component at least one through-hole solder connection on the assembly is positioned over the opening.

17. The apparatus of claim 15, wherein each testing stage includes a stage electrical testing component configured to facilitate electrical testing of the assemblies while the assemblies are mounted in the tray.
